(19) United States
(12) Patent Application Publication
(10) Pub. No.: US 2023/0274077 A1
(43) Pub. Date: Aug. 31, 2023

(54) INFORMATION PROCESSING APPARATUS, NON-TRANSITORY COMPUTER READABLE MEDIUM STORING PROGRAM, AND INFORMATION PROCESSING METHOD

(71) Applicant: FUJIFILM Business Innovation Corp., Tokyo (JP)

(72) Inventor: Takao MAEKAWA, Kanagawa (JP)

(73) Assignee: FUJIFILM Business Innovation Corp., Tokyo (JP)

(21) Appl. No.: 17/897,245

(22) Filed: Aug. 29, 2022

(30) Foreign Application Priority Data
Jan. 31, 2022 (JP) 2022-013271

(51) Int. Cl. G06F 40/109; G06F 40/166

(52) U.S. Cl. CPC G06F 40/109; G06F 40/166

(57) ABSTRACT

An information processing apparatus includes a processor configured to, in a case where a new text that does not fit in a text input field with a fixed size is input, not change a size of a text within a preset range and reduce a size of a text other than the text within the preset range, based on an input position at which the text is input, to display all the texts input in the text input field.

### CROSS-REFERENCE TO RELATED APPLICATIONS

This application is based on and claims priority under 35 USC 119 from Japanese Patent Application No. 2022-013271 filed Jan. 31, 2022.

### BACKGROUND

### (I) Technical Field

The present invention relates to an information processing apparatus, a non-transitory computer readable medium storing a program, and an information processing method.

### (II) Related Art

In WO2004/034278A, in a case where a new text that does not fit in a text input field such as a text box having a fixed size is input, a size of the text is reduced such that the entire input text fits in the text input field.

### SUMMARY

In a case where a new text that does not fit in the text input field such as a text box with a fixed size is input, a size of the text is considered to be reduced such that the entire input text fits in the text input field. However, in a case where the number of input texts increases, there is a problem that the size of the text becomes too small and readability of an input portion of the text deteriorates.

Aspects of non-limiting embodiments of the present disclosure relate to an information processing apparatus, a non-transitory computer readable medium storing a program, and an information processing method that can maintain, in a case where a new text that does not fit in a text input field having a fixed size is input, readability of an input portion of the text.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a processor configured to, in a case where a new text that does not fit in a text input field with a fixed size is input, not change a size of a text within a preset range and reduce a size of a text other than the text within the preset range, based on an input position at which the text is input, to display all the texts input in the text input field.

### BRIEF DESCRIPTION OF THE DRAWINGS

Exemplary embodiment(s) of the present invention will be described in detail based on the following figures, wherein:

FIG. 1 is a diagram showing a system configuration of a data processing system according to an exemplary embodiment of the present invention;

FIG. 2 is a block diagram showing a hardware configuration of an information processing apparatus according to an exemplary embodiment of the present invention;

FIG. 3 is a block diagram showing a functional configuration of the information processing apparatus according to an exemplary embodiment of the present invention;

FIG. 4 is a diagram for describing processing in a case where a new text that does not fit in a text input field having a fixed size is input;

FIG. 5 is a diagram showing an example in a case where emphasis processing is performed on a text within a text size maintenance range in the text input field;

FIG. 6 is a diagram showing an example in a case where a range of one word immediately before an input position is set as the text size maintenance range;

FIG. 7 is a diagram showing an example in a case where a range of three words immediately before an input position is set as the text size maintenance range;

FIG. 8 is a diagram showing an example in a case where the emphasis processing is performed on the text within the text size maintenance range of the text input field shown in FIG. 7;

FIG. 9 is a diagram showing an example in a case where an input language is English and a range of a sentence being input is set as the text size maintenance range;

FIG. 10 is a diagram showing an example in a case where the input language is Japanese and a range of a sentence being input is set as the text size maintenance range;

FIG. 11 is a diagram showing an example in a case where the emphasis processing is performed on the text within the text size maintenance range of the text input field shown in FIG. 9;

FIG. 12 is a diagram showing an example in a case where the input language is English and a range of a part of the sentence being input is set as a text size maintenance range;

FIG. 13 is a diagram showing an example in a case where the input language is Japanese and a range of a part of the sentence being input is set as a text size maintenance range;

FIG. 14 is a diagram showing an example in a case where the emphasis processing is performed on the text within the text size maintenance range of the text input field shown in FIG. 12; and

FIG. 15 is a flowchart for describing a flow of processing at a time of text input in a personal computer.

### DETAILED DESCRIPTION

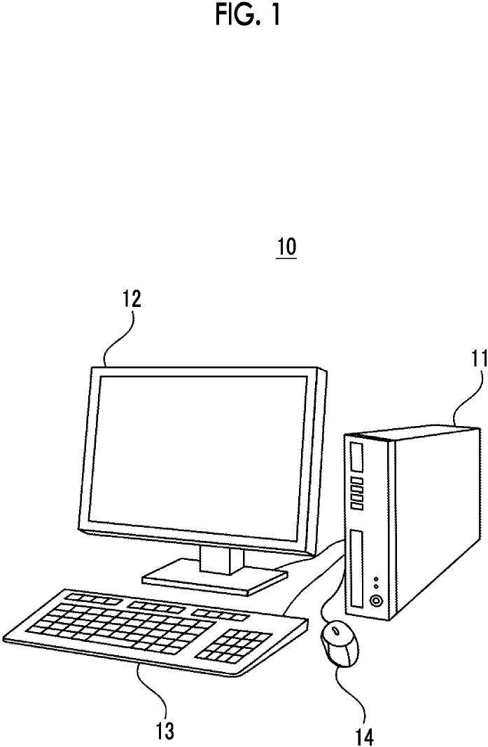

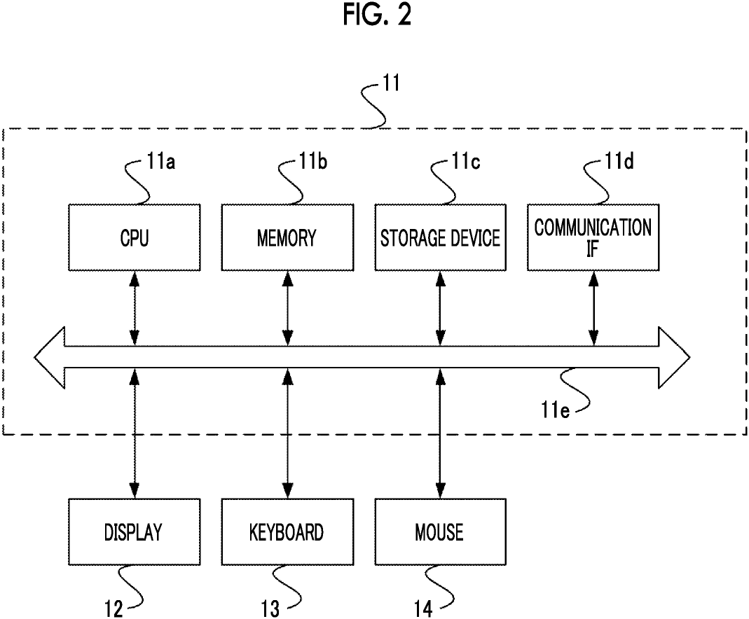

Next, exemplary embodiments of the present invention will be described in detail with reference to drawings. FIG. 1 is an external view of a personal computer 10 according to an exemplary embodiment of the present invention. FIG. 2 is a diagram showing a hardware configuration of the personal computer 10 according to an exemplary embodiment of the present invention.

The personal computer 10 of the present exemplary embodiment is a device capable of performing text editing in a text input field such as a text box. As shown in FIG. 1, the personal computer 10 of the present exemplary embodiment has a computer body 11, a display 12 as a display device, a keyboard 13 as an input device, and a mouse 14 as an input device. The personal computer 10 is an example of an information processing apparatus in the technique of the present invention.

As shown in FIG. 2, the computer body 11 has a central processing unit (CPU) 11a, a memory 11b, a storage device 11c such as a hard disk drive, a communication interface (hereinafter abbreviated as IF) 11d for transmitting/receiving data to/from an external device and the like, and a control bus 11e. The CPU 11a, the memory 11b, the storage device 11c, the communication IF 11d, the display 12, the keyboard 13, and the mouse 14 are connected via the control bus 11e.

The CPU 11a is a processor configured to execute predetermined processing based on a control program stored in the memory 11b or the storage device 11c to control an operation of the personal computer 10. In the present exemplary embodiment, the CPU 11a reads out and executes the control program stored in the memory 11b or the storage device 11c. However, the present invention is not limited thereto. The control program may be provided in a form of being recorded on a computer-readable recording medium. For example, the program may be provided in a form of being recorded on optical disks such as a compact disc (CD)-read only memory (ROM) and a digital versatile disc (DVD)-ROM or in a form of being recorded on semiconductor memories such as a universal serial bus (USB) memory and a memory card. Further, the control program may be acquired from an external apparatus via a communication line connected to the communication IF 11d.

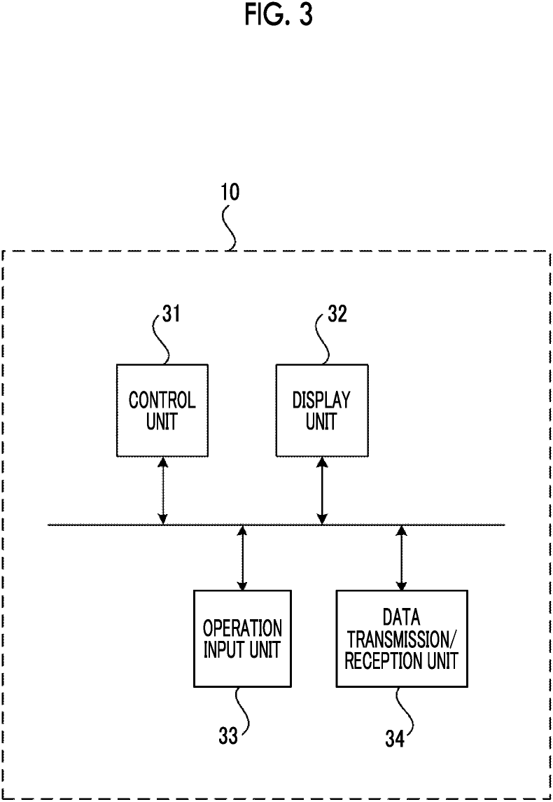

FIG. 3 is a block diagram showing a functional configuration of the personal computer 10 realized by executing the above control program. As shown in FIG. 3, the personal computer 10 of the present exemplary embodiment has a control unit 31, a display unit 32, an operation input unit 33, and a data transmission/reception unit 34.

The control unit 31 controls the overall operation of the personal computer 10. The display unit 32 is controlled by the control unit 31 to display various types of information to a user. In the operation input unit 33, various types of operation information performed by the user are input. The data transmission/reception unit 34 transmits/receives data to/from an external device.

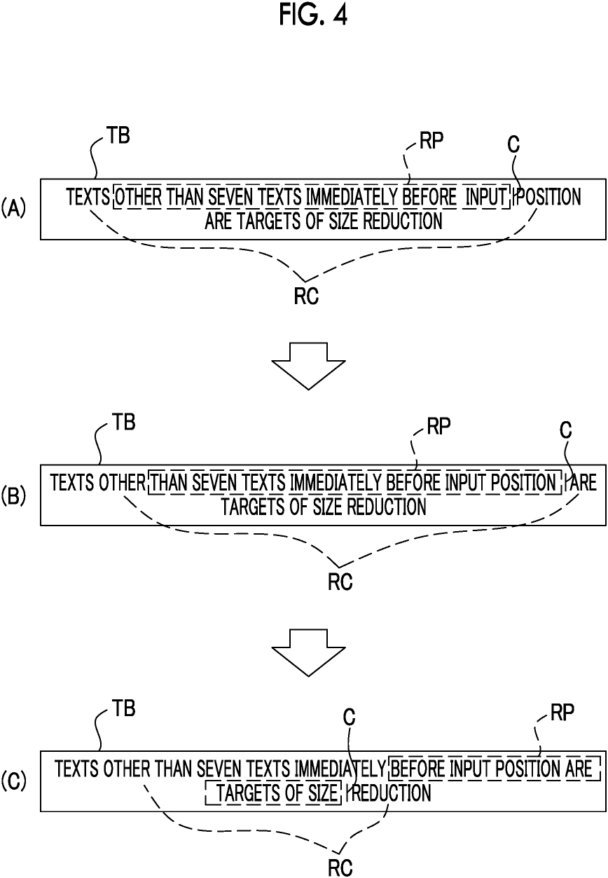

In the personal computer 10 of the present exemplary embodiment, the control unit 31 displays a text input field TB (refer to FIG. 4) having a fixed size on the display unit 32. Processing of the control unit 31 in a case where a text is input to the text input field TB by the user via the operation input unit 33 will be described below.

In a case where a new text that does not fit in the text input field TB (refer to FIG. 4) having the fixed size is input, the control unit 31 does not change a size of a text within a preset range and reduces a size of a text other than the text within the preset range, based on an input position at which the text is input, to display all the texts input in the text input field TB.

The control unit 31 may not change a size of a text within a preset range immediately before the input position and reduce a size of a text other than the text within the preset range to display all the texts input in the text input field TB.

The control unit 31 may not change a size of a text within a preset number of texts immediately before the input position and reduce a size of texts other than the text within a preset number of texts to display all the texts input in the text input field TB.

Hereinafter, processing in the personal computer 10 of the present exemplary embodiment will be described in detail. FIG. 4 is a diagram for describing processing in a case where the new text that does not fit in the text input field having the fixed size is input. Here, as an example, an aspect will be described in which in a case where a new text that does not fit in the text input field TB having a fixed size is input, a size of seven texts immediately before the input position is not changed and a size of texts other than the seven texts is reduced to display all the texts input in the text input field TB.

As shown in FIG. 4, a cursor C indicating the input position of a text and a text input by the user are displayed in the text input field TB. A range of seven texts immediately before the cursor C is a text size maintenance range RP in which a size of a text is not changed and maintained in a case where a new text that does not fit in the text input field TB is input. A range other than the text size maintenance range RP of the text input field TB is a text size change range RC in which a size of a text is changed in a case where a new text that does not fit in the text input field TB is input.

The control unit 31 displays all texts input in the text input field TB in the same text size until the texts cannot fit in the text input field TB. In this case, a text size, a font type, a display color, a typeface, and the like are not particularly limited and can be set randomly. A part (A) in FIG. 4 shows a state in which texts having the number of texts that exactly fit in the text input field TB are input. In a case where a new text is input at a position of the cursor C in this state, the text input in the text input field TB cannot fit in the text input field TB.

Therefore, as shown in a part (B) in FIG. 4, the control unit 31 does not change a size of texts in the text size maintenance range RP of seven texts immediately before the cursor C and reduces a size of texts in the text size change range RC, which is a range other than the text size maintenance range RP of the text input field TB. In this case, the control unit 31 reduces the size of the texts in the text size change range RC by one size until all the texts input in the text input field TB fit in the field. In other words, the control unit 31 sets the size of the texts in the text size change range RC to the largest size among sizes that all the texts input in the text input field TB fit in the field.

A size of one size when the size of the text is changed can be set to any size, for example, 0.5 point, 1 point, or 2 points of a font size. Further, the size of one size when the size of the text is changed may be constant regardless of a current size of the text in the text size change range RC or may be changed according to the current size of the text in the text size change range RC.

In a case where the size of one size is changed, the size of one size when the size of the text is changed may be smaller as the current size of the texts in the text size change range RC is smaller. For example, the size of one size may be set to 2 points in a case where the current size of the texts in the text size change range RC is 20 points or more, set to 1 point in a case where the current size thereof is less than 20 points and 10 points or more, and set to 0.5 points in a case where the current size thereof is less than 10 points.

In a case where a new text is further input at the position of the cursor C from the state of the part (B) of FIG. 4, the text input in the text input field TB cannot fit in the text input field TB again. Therefore, as shown in a part (C) of FIG. 4, the control unit 31 further reduces the size of the texts in the text size change range RC such that all the texts input in the text input field TB fit in the field.

Processing of the control unit 31 in a case where the size of the texts in the text size change range RC is reduced, then a text in the text input field TB is deleted, and there is a margin for displaying a new text in the text size change range RC is not particularly limited. For example, the following processing can be performed.

Contrary to the above processing, the control unit 31 may expand the size of the texts in the text size change range RC by one size until the texts input in the text input field TB cannot fit in the text input field TB to set the size thereof to the largest size among the sizes that all the texts input in the text input field TB fit in the field.

The control unit 31 may maintain the once reduced size of the texts in the text size change range RC even in a case where there is a margin for displaying a new text in the text size change range RC.

With the above aspect, the readability of the input portion of the text is maintained even in a case where a new text that does not fit in the text input field TB having a fixed size is input.

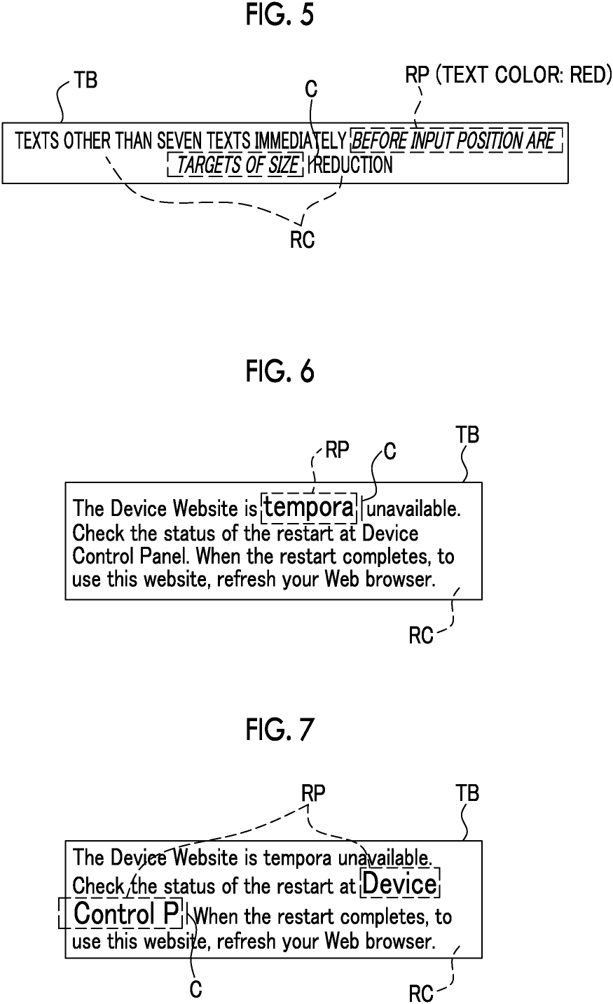

The texts in the text size maintenance range RP near the cursor C are texts that the user pays particular attention to in a case of inputting a text in the text input field TB. Therefore, in the personal computer 10 of the present exemplary embodiment, the control unit 31 may perform emphasis processing on the texts in the text size maintenance range RP that are not changed in size, as shown in FIG. 5 as an example. In this case, the emphasis processing may be processing in which any one or both of the display color and typeface of the text that is not changed in size is different from the text that is changed in size.

FIG. 5 shows an example in which both the display color and typeface of the texts in the text size maintenance range RP are different from the texts in the text size change range RC. In detail, the display color of the texts in the text size change range RC is black and the typeface is standard, while the display color of the texts in the text size maintenance range RP is red and the typeface is bold and italic.

The control unit 31 may not change a size of texts within the preset number of words immediately before the input position including a word being input and reduce a size of texts other than the texts therewithin to display all the texts input in the text input field TB.

That is, as shown in FIG. 6, the control unit 31 may set a range of one word immediately before the cursor C as the text size maintenance range RP. Further, as shown in FIG. 7, the control unit 31 may set a range of a plurality of words immediately before the cursor C as the text size maintenance range RP. FIG. 7 shows an example in which a range of three words is set as the text size maintenance range RP.

An input language in this case is not limited to a language such as English written with a space between words and may be a language written without a space between words such as Japanese. Here, “written with space between words” is a writing method in which a space is inserted in a word separation. In a case where the input language is a language written with a space between words, a word can be identified by a space symbol between texts. Further, in a case where the input language is a language written without a space between words, a word in a sentence may be identified by a known sentence recognition technique.

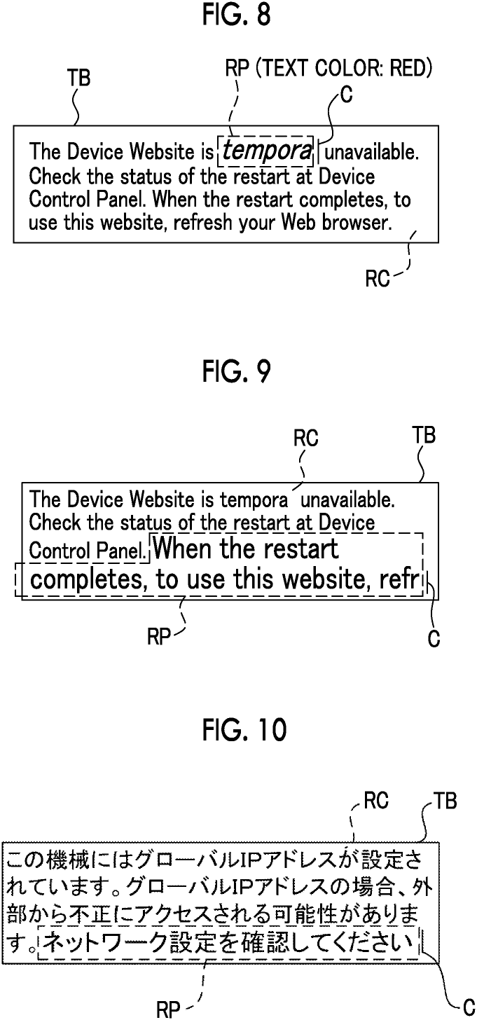

In this case, the emphasis processing may be also performed on the texts in the text size maintenance range RP, as shown in FIG. 8.

In a case of a language in which sentences are separated by a specific symbol, the control unit 31 may not change a size of texts included in a sentence being input and reduce a size of texts other than the texts included in the sentence being input to display all the texts input in the text input field TB. The language in which sentences are separated by a specific symbol is, for example, English in which sentences are separated by a period “.” and Japanese in which sentences are separated by a punctuation mark “∘”. In this case, a range from the position of the cursor C to immediately before the nearest symbol on a front side of the cursor C can be identified as the sentence being input.

That is, as shown in FIGS. 9 and 10, the control unit 31 may set the range of the sentence being input immediately before the cursor C as the text size maintenance range RP. FIG. 9 shows an example in a case where the input language is English. FIG. 10 shows an example in a case where the input language is Japanese.

In this case, the emphasis processing may be also performed on the texts in the text size maintenance range RP, as shown in FIG. 11.

In a case of a language in which a part of a sentence is separated by a specific symbol, the control unit 31 may not change a size of texts included in a part of the sentence being input and reduce a size of texts other than the texts included in a part of the sentence being input to display all the texts input in the text input field TB. The language in which a part of the sentence is separated by a specific symbol is, for example, English in which a part of the sentence is separated by a period “.” and a comma “,”, and Japanese in which a part of the sentence is separated by a punctuation mark “∘” and a pause mark “,”. In this case, a range from the position of the cursor C to immediately before the nearest symbol on a front side of the cursor C can be identified as a part of the sentence being input.

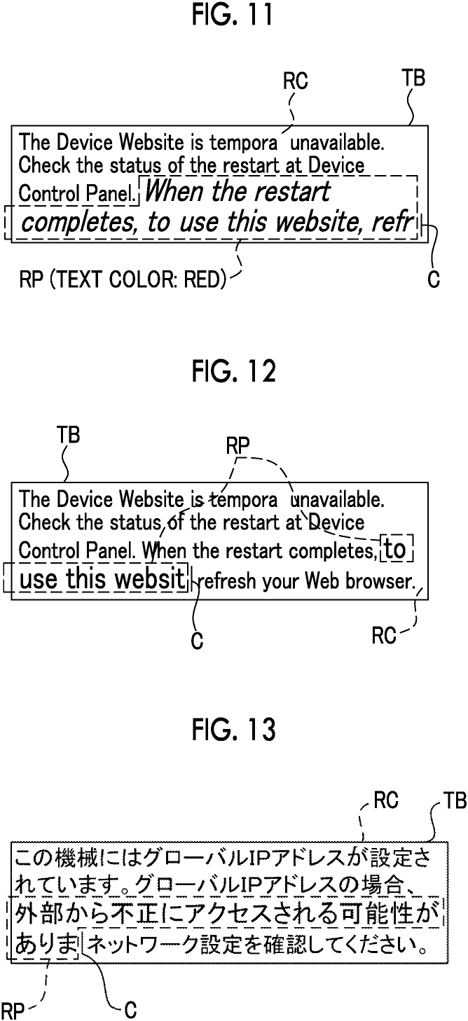

That is, as shown in FIGS. 12 and 13, the control unit 31 may set the range of a part of the sentence being input immediately before the cursor C as the text size maintenance range RP. FIG. 12 shows an example in a case where the input language is English. FIG. 13 shows an example in a case where the input language is Japanese.

In this case, the emphasis processing may be also performed on the texts in the text size maintenance range RP, as shown in FIG. 14.

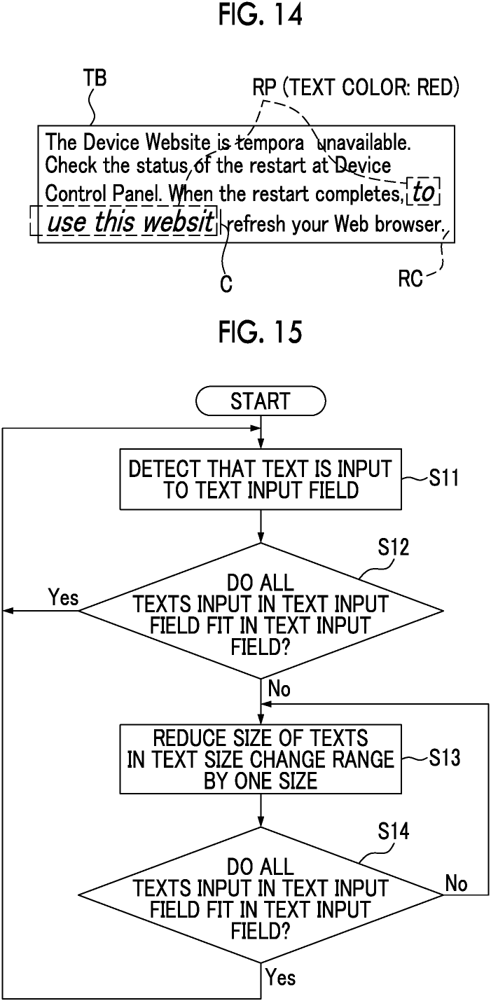

Next, a flow of processing at the time of text input in the personal computer 10 of the present exemplary embodiment will be described with reference to a flowchart of FIG. 15.

In a case where detection is made in step S11 that a new text is input to the text input field TB, the control unit 31 determines whether or not all texts input to the text input field TB fit in the text input field TB in step S12.

In a case where determination is made in step S12 that all the texts input in the text input field TB fit in the text input field TB, the control unit 31 transitions immediately before step S11 and waits until a next text is detected.

In a case where determination is made in step S12 that all the texts input in the text input field TB do not fit in the text input field TB, the control unit 31 reduces the size of the texts in the text size change range RC of the text input field TB by one size in step S13.

Next, in step S14, the control unit 31 determines whether or not all the texts input in the text input field TB fit in the text input field TB.

In a case where determination is made in step S14 that all the texts input in the text input field TB fit in the text input field TB, the control unit 31 transitions immediately before step S11 and waits until a next text is detected.

In a case where determination is made in step S12 that all the texts input in the text input field TB do not fit in the text input field TB, the control unit 31 transitions to step S13. The control unit 31 repeats steps S13 and S14 until all the texts input in the text input field TB fit in the text input field TB.

### Modification Example

Although the data processing system of an exemplary embodiment of the present invention has been described above, the present invention is not limited to the above exemplary embodiment and may be changed as appropriate.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a processor configured to:
in a case where a new text that does not fit in a text input field with a fixed size is input, not change a size of a text within a preset range and reduce a size of a text other than the text within the preset range, based on an input position at which the text is input, to display all the texts input in the text input field.

2. The information processing apparatus according to claim 1, wherein the processor is configured to:
not change a size of a text within a preset range immediately before the input position and reduce a size of a text other than the text within the preset range to display all the texts input in the text input field.

3. The information processing apparatus according to claim 2, wherein the processor is configured to:
not change a size of a text within a preset number of texts immediately before the input position and reduce a size of a text other than the text within the preset number of texts to display all the texts input in the text input field.

4. The information processing apparatus according to claim 2, wherein the processor is configured to:
not change a size of texts within a preset number of words immediately before the input position including a word being input and reduce a size of texts other than the texts within the preset number of words to display all the texts input in the text input field.

5. The information processing apparatus according to claim 2, wherein the processor is configured to:
in a case of a language in which sentences are separated by a specific symbol, not change a size of texts included in a sentence being input and reduce a size of texts other than the texts included in the sentence to display all the texts input in the text input field.

6. The information processing apparatus according to claim 2, wherein the processor is configured to:
in a case of a language in which a part of a sentence is separated by a specific symbol, not change a size of texts included in a part of a sentence being input and reduce a size of texts other than the texts included in the part of the sentence to display all the texts input in the text input field.

7. The information processing apparatus according to claim 1, wherein the processor is configured to:
perform emphasis processing on the text that is not changed in size.

8. The information processing apparatus according to claim 2, wherein the processor is configured to:
perform emphasis processing on the text that is not changed in size.

9. The information processing apparatus according to claim 3, wherein the processor is configured to:
perform emphasis processing on the text that is not changed in size.

10. The information processing apparatus according to claim 4, wherein the processor is configured to:
perform emphasis processing on the texts that are not changed in size.

11. The information processing apparatus according to claim 5, wherein the processor is configured to:
perform emphasis processing on the texts that are not changed in size.

12. The information processing apparatus according to claim 6, wherein the processor is configured to:
perform emphasis processing on the texts that are not changed in size.

13. The information processing apparatus according to claim 7,
wherein in the emphasis processing, any one or both of a display color and typeface of the text that is not changed in size is different from the text that is changed in size.

14. The information processing apparatus according to claim 8,
wherein in the emphasis processing, any one or both of a display color and typeface of the text that is not changed in size is different from the text that is changed in size.

15. The information processing apparatus according to claim 9,
wherein in the emphasis processing, any one or both of a display color and typeface of the text that is not changed in size is different from the text that is changed in size.

16. The information processing apparatus according to claim 10,
wherein in the emphasis processing, any one or both of a display color and typeface of the texts that are not changed in size is different from the texts that are changed in size.

17. The information processing apparatus according to claim 11,
wherein in the emphasis processing, any one or both of a display color and typeface of the texts that are not changed in size is different from the texts that are changed in size.

18. The information processing apparatus according to claim 12,
wherein in the emphasis processing, any one or both of a display color and typeface of the texts that are not changed in size is different from the texts that are changed in size.

19. A non-transitory computer readable medium storing a program causing a computer to execute:
detecting that a text that does not fit in a text input field with a fixed size is input; and
not changing a size of a text within a preset range and reducing a size of a text other than the text within the preset range, based on an input position, to display all the texts input in the text input field, in a case where the detection is made.

20. An information processing method comprising:
detecting that a text that does not fit in a text input field with a fixed size is input; and
not changing a size of a text within a preset range and reducing a size of a text other than the text within the preset range, based on an input position, to display all the texts input in the text input field, in a case where the detection is made.
